(19) United States
(12) Patent Application Publication
(10) Pub. No.: US 2026/0205163 A1
(43) Pub. Date: Jul. 16, 2026

(54) SYSTEM AND METHOD FOR A NON-VOLATILE RECONFIGURABLE METASURFACE

(71) Applicant: Dell Products LP, Round Rock, TX (US)

(72) Inventors: Tejinder Singh, Manotick (CA); Navjot Kaur Khaira, Manotick (CA); Harpreet S. Narula, Austin, TX (US)

(73) Assignee: Dell Products LP, Round Rock, TX (US)

(21) Appl. No.: 19/025,768

(22) Filed: Jan. 16, 2025

(51) Int. Cl. H04B 7/04

(52) U.S. Cl. CPC H04B 7/04013

(57) ABSTRACT

A system and method comprising a reconfigurable metasurface to manipulate an electromagnetic wave includes a plurality of reconfigurable metasurface unit cells. Each of the plurality of reconfigurable metasurface unit cells includes a non-reconfigurable metal fixed center node, non-reconfigurable metal fixed ring, a plurality of metasurface reconfigurable split rings and a plurality of refractory heaters to selectably heat each of the plurality of metasurface reconfigurable split rings to switch, individually, a non-volatile phase change material of each of the plurality of metasurface reconfigurable split rings between a conductive state and dielectric state via a plurality of contact pads operatively coupled to the plurality of refractory heaters. Selection of the plurality of metasurface reconfigurable split rings to be transitioned to a conductive state may be controlled by a metasurface controller to adjust directionality of electromagnetic wave reflection by the plurality of reconfigurable metasurface unit cells.

### FIELD OF THE DISCLOSURE

The present disclosure generally relates to metasurface systems for reflecting or directing radiofrequency signals used in wireless communications for information handling systems. The present disclosure more specifically relates systems and methods for a reconfigurable metasurface with an array of metasurface unit cells reconfigurable to direct reflection or directionality of radiofrequency signals transmitted between a source information handling system and a target information handling system and a return radiofrequency path to provide improved range or performance in a wireless environment.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities that may include wireless communications. The information handling system may be used to operate a wireless interface adapter and radio system for transmission of radio signals to a target receiving wireless device or access point device or to receive radio signals from the target wireless device or access point device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system wirelessly interfacing with a metasurface unit cell array comprising a plurality of unit cells according to an embodiment of the present disclosure;

FIG. 2A is an exploded graphic diagram illustrating a perspective view of a reconfigurable metasurface unit cell of a metasurface unit cell array according to an embodiment of the present disclosure;

FIG. 2B is a side, exploded graphic diagram illustrating a cross-section of a reconfigurable metasurface unit cell of a metasurface unit cell array according to another embodiment of the present disclosure;

FIG. 3A is a top view diagram showing a plurality of metasurface reconfigurable rings of a reconfigurable metasurface unit cell according to an embodiment of the present disclosure;

FIG. 3B is a top view diagram showing a plurality of contact pads of a bottom layer of a reconfigurable metasurface unit cell according to an embodiment of the present disclosure;

FIG. 4 is a top view of a plurality of reconfigurable metasurface unit cells of at least part of a metasurface unit cell array depicting various activation states of the plurality of reconfigurable metasurface unit cells according to an embodiment of the present disclosure;

FIG. 5 is a side, exploded graphic diagram illustrating a perspective view of a plurality of reconfigurable metasurface unit cells of at least part of a metasurface unit cell array according to another embodiment of the present disclosure;

FIG. 6 graphic diagram of a metasurface unit cell array and electromagnetic wave emission properties according to an embodiment of the present disclosure;

FIG. 7 is a graphic diagram of various emission states of a metasurface unit cell array operated by a field programmable gate array (FPGA) or other metasurface controller according to an embodiment of the present disclosure; and

FIG. 8 is a block diagram of a method of controlling a metasurface unit cell array to dynamically change the directionality and feed distance of reflected electromagnetic (EM) wave beams for radiofrequency communications according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Wireless data transmission from a transmitting device to a receiving device allows for rapid data transmission and communication between multiple devices. Devices may include wirelessly enabled information handling systems, access point devices, or any computing device, such as internet of things (IoT) devices that are wirelessly capable. As data transmission requirements increase, the electromagnetic (EM) wave (e.g., 5G technologies using 20 to 50 GHz wireless signals or WiFi 6 signals at 2.4 GHz, 5 GHz or even 6 GHz) used to transmit these ever-increasing amounts of data are shortened or may benefit from extended range such as reach around radiofrequency barriers such as walls. However , the ability to penetrate walls and building structures as well as transmit around these relatively large structures may be limited with such wireless systems. Additionally, material properties of these buildings and other structures effect reflection from, and transmission of, EM waves through building materials and on the absorption of EM wave energy in those materials, which gives rise to attenuation of the EM signal. Other EM wave-inhibiting mechanisms include diffraction from the edges of materials and scatter from rough edges also exist in radiofrequency environments such as rooms within a building. Further, most buildings behave as lossy dielectrics as building materials as well as occasionally conductive material that further inhibit or scatter EM wave propagation.

With the advent of massive multiple input multiple output (MIMO) wireless technologies, a group of antennas at both the transmitting device and receiving device may provide high spectral and energy efficient wireless communication systems. In an embodiment of the present disclosure, a series of thin surfaces or panels can be installed on building surfaces or other surfaces within a radiofrequency environment that may be used to steer these EM waves and expand wireless range or signal quality. Some of these surfaces may include metasurface unit cells in arrays referred to as metasurface arrays in embodiments herein. Further, embodiments of the present disclosure may include reconfigurable intelligent surfaces (RISs) or “reconfigurable metasurfaces” that include engineered materials designed to have properties not found in naturally occurring materials to allow for reconfigurability of reconfigurable metasurface unit cells in embodiments of the present disclosure. These metasurfaces are crafted and adjusted with a control system to manipulate EM waves in ways that non-reconfigurable metasurface unit cells cannot, thereby often achieving effects like negative refraction as well as control over directionality of reflection and redirection of EM waves of the radiofrequency signals.

The reconfigurable metasurfaces of embodiments of the present disclosure may be used within current infrastructures having radiofrequency environments within, for example, office settings or home settings where radiofrequency data communication could benefit from these reconfigurable metasurfaces relaying EM wave transmissions around corners, into various office spaces, and/or into various rooms. In some previous examples of reconfigurable unit cells , the use of PIN diodes and varactor diodes for reconfigurability causes these metasurfaces may have high losses, parasitic effects, and limited phase tunability. These components within the prior metasurface unit cell also complicate soldering and biasing in dense arrays thereby reducing performance and scalability. These prior metasurfaces also require continuous power supply increasing the power consumption associated with the metasurfaces. A more efficient, scalable, and precisely integrated reconfigurable metasurface is needed.

To address these and other issues, the present specification describes a reconfigurable metasurface to manipulate an electromagnetic wave. The reconfigurable metasurface may include a plurality of reconfigurable metasurface unit cells formed across the surface of the reconfigurable metasurface. In an embodiment, each unit cell may include a first metasurface reconfigurable split ring, a second metasurface reconfigurable split ring, and a third metasurface reconfigurable split ring as well as a conductive center node and a conductive outer ring. It is appreciated that any number of metasurface reconfigurable split rings may be formed into the reconfigurable metasurface unit cell, and the present specification contemplates these other form factors, for example differing shapes other than a rings, of each of the reconfigurable metasurface unit cells. In an embodiment, the metasurface reconfigurable split rings may be made of a phase change material that, when heated, changes from a first amorphous state to a second crystalline state. Thus, when a temporary amount heat is applied to each of the metasurface reconfigurable split rings, individually, the phase change material may switch between a high resistance dielectric state to a low resistance conductive state which may change the operation of the reconfigurable metasurface unit cell between the conductive center node and conductive outer ring. In an embodiment, these phase change materials may include, for example, geranium telluride (GeTe), antimony telluride (SbTe), chalcogenide (GeSbTe), and the like. Application of heat may be applied for a short duration to switch the phase of these phase change materials back and forth between the high resistance dielectric state to the low resistance conductive state.

In order to heat, individually, each of the metasurface reconfigurable split rings, each of the reconfigurable metasurface unit cells may include a plurality of refractory heaters. In an example embodiment having three metasurface reconfigurable split rings, each reconfigurable metasurface unit cell includes a first refractory heater to selectably heat the first metasurface reconfigurable split ring to switch the first metasurface reconfigurable split ring between a conductive state and dielectric state, a second refractory heater to selectably heat the second metasurface reconfigurable split ring to switch the second metasurface reconfigurable split ring between a conductive state and dielectric state, and a third refractory heater to selectably heat the third metasurface reconfigurable split ring to switch the third metasurface reconfigurable split ring between a conductive state and dielectric state.

In an embodiment, a plurality of contact pads are included within each of the dielectric unit cells that operatively couple the first refractory heater, the second refractory heater, the third refractory heater to a metasurface power management unit (PMU) and a reconfigurable metasurface controller to provide power to the first refractory heater, the second refractory heater, and the third refractory heater to change the electromagnetic reflective properties of the metasurface. In an embodiment, a field programmable gate array (FPGA) or other reconfigurable metasurface and digital-to-analog converter (DAC) may be used to control power provided to each of the first refractory heater, the second refractory heater, the third refractory heater so that each of the first metasurface reconfigurable split ring, the second metasurface reconfigurable split ring, and the third metasurface reconfigurable split ring within each unit cell may be heated for a brief duration in order to selectively switch each of these metasurface reconfigurable split rings between the amorphous state and the crystalline state. A second heating of a brief duration will selectively switch the phase change materials of each of these metasurface reconfigurable split rings back again to the previous state allowing for a toggle effect of conductivity for these metasurface reconfigurable split rings.

By switching any combination or none of the first metasurface reconfigurable split ring, second metasurface reconfigurable split ring, and third metasurface reconfigurable split ring between the amorphous state and the crystalline state, the reconfigurable metasurface unit cells of a reconfigurable metasurface unit cell array may be configured to redirect transmitted EM waves and beam steer those EM waves in a desired direction. Additionally, because the heating of the phase change material can be achieved by applying thermal energy such as a heat pulse with a certain amplitude and width (on the order of nanoseconds) through electrically insulated high-speed refractory heaters, the constant application of power is not needed thereby reducing the need for a dedicated power source of any substantial amount. Indeed, in some embodiments, these phase change materials hold their states as either crystalline or amorphous as long as it is not actuated with another heat pulse.

Thus, the presently-described reconfigurable metasurface unit cell array of embodiments herein is real-time configurable that can optimize signal direction and phase continuously, responding to a dynamic wireless environment. The switching time of the phase change material between amorphous states and crystalline states is in nanoseconds resulting in the reconfiguration time of the reconfigurable metasurface unit cell array being completed within a sub-millisecond timeframe. Still further, the reconfigurable metasurface unit cell array of embodiments herein is energy efficient with the power only being required intermittently during the reconfiguration phase when the first refractory heater, the second refractory heater, the third refractory heater are actuated as well as low power for the reconfigurable metasurface controller or PMU. Once the appropriate refractory pattern is achieved, the phase change materials retain their state without the need for ongoing power applied. The reconfigurable metasurface unit cell array of embodiments herein is also more easily scalable via use of the integrated first refractory heater, the second refractory heater, the third refractory heater, or other refractory heaters as needed in a network among the plurality of reconfigurable metasurface unit cells in any scalable array size. Complication of forming the reconfigurable metasurface unit cells is minimal as is the power requirements for operation.

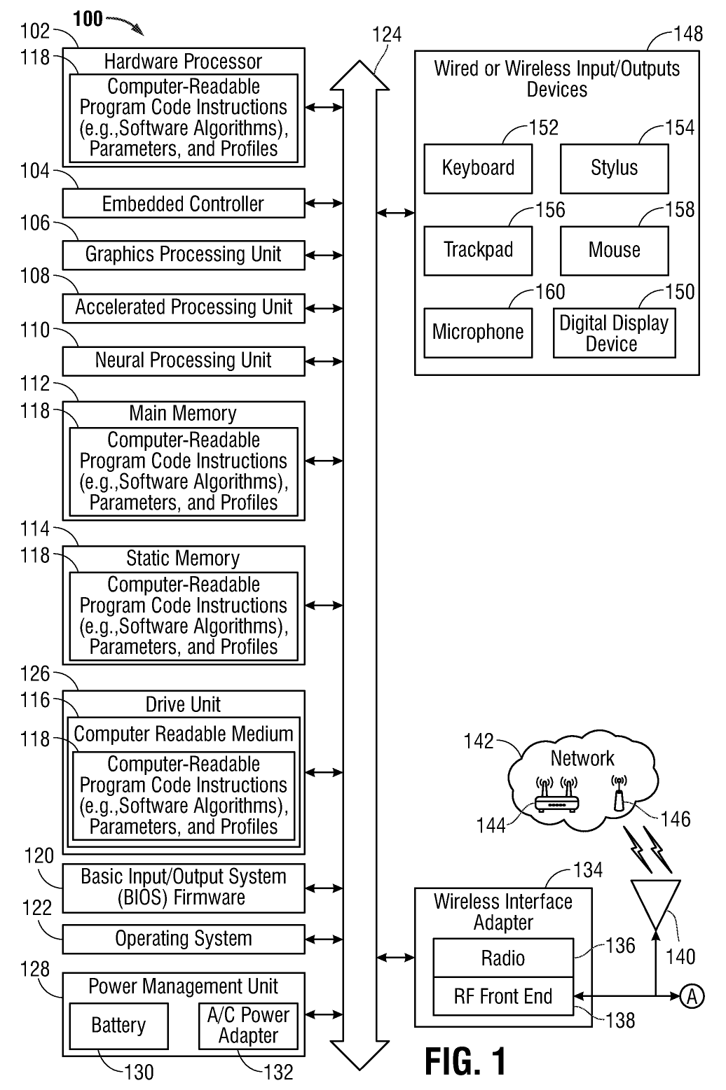

Turning now to the figures, FIG. 1 illustrates an information handling system 100 similar to the information handling systems according to several aspects of the present disclosure that may operate as a source or target radiofrequency device for use with the reconfigurable metasurfaces of the embodiments of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Computer-readable program code instructions stored in static memory 114, main memory 112, or drive unit 126 may be involved in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a digital display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms) parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resource (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing computer-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, digital display device 150, stylus 154, trackpad 156, microphone 160, among other peripheral devices.

As described herein, the information handling system 100 further includes a digital display device 150. The digital display device 150 in an embodiment may function as a liquid crystal display (LCD), an organic light emitting diode (OLED), a flat panel display, or a solid-state display. It is appreciated that the digital display device 150 may be wired or wireless and may be an external digital display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the digital display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among plural devices such as with Bluetooth® or to a network 142 such as with a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth ®, BLE, proprietary RF protocol, or other WPAN or WLAN protocols and plural such protocols may be used for communication with and among any wireless peripheral device to be paired or paired with the information handling system 100 or other information handling systems.

In other embodiments, the wireless interface device 134 with its radio 136, RF front end 138 and antenna 140 is used to communicate with a WWAN or and WLAN which may each include an AP 144 or base station 146 used to operatively couple the information handling system 100 to a network 142 via the wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols. It is appreciated that the information handling system 100 may wirelessly communicate with a target receiver device 178 via the reconfigurable metasurface unit cell array 162. The receiver device 178 may be any other device and may include the AP 144, the base station 146, or any other computing device described herein. Additionally, the information handling system 100 and receiver device 178 may be capable of transmitting wireless data using, for example, EM waves that include 5G mm wave lengths such as those included within the 20-50 GHz range or WiFi wavelengths such as 2.4 GHz, 5 GHz, 6 GHz or others to be used with later versions of WiFi. Thus, in an embodiment, the reconfigurable metasurface unit cell array 162 is capable of relaying these types of mm waves.

In an embodiment, the wireless interface adapter 134 may operate in accordance with any wireless data communication standards. To communicate with a wireless local area network and/or the receiver device 178, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application computer-readable program code instructions, parameters, and profiles 118 may be coordinated by an operating system (OS) 122, and/or via an application programming interface (API) include a unified device API described herein. An example OS 122 may include Windows ®, Android ®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 may operatively communicate with a receiver device 178 (e.g., another information handling system, an AP 144, a base station 146, etc.) via an intermediary-placed reconfigurable metasurface unit cell array 162. This reconfigurable metasurface unit cell array 162 may be configured to relay or otherwise reflect wireless EM waves transmitted from the information handling system 100 and may extend the wireless range or improve signal of the information handling system 100 in communications with a target wireless device. Again, these EM waves may include any type of EM wave including low-band, mid-band, or high-band millimeter-wave EM waves. These may include 600-900 MHz, 1.7-6 GHz, and 24-47 GHz, among other frequencies.

The reconfigurable metasurface unit cell array 162 may include a plurality of reconfigurable metasurface unit cells, such as the first reconfigurable metasurface unit cell 164-1 and a second reconfigurable metasurface unit cell 164-2 is shown in FIG. 1. It is appreciated that the reconfigurable metasurface unit cell array 162 may contain any number of reconfigurable metasurface unit cells 164-1, 164-2. In one example embodiment, the reconfigurable metasurface unit cell array 162 may contain two-hundred and fifty-six reconfigurable metasurface unit cells 164-1, 164-2 arranged in a sixteen-by-sixteen array. It is appreciated that the reconfigurable metasurface unit cell array 162 may include any plurality of reconfigurable metasurface unit cells 164-1, 164-2 in any arrangement of those unit cells 164-1, 164-2. As described herein, the reconfigurable metasurface unit cells 164-1, 164-2 within the reconfigurable metasurface unit cell array 162 may be used to, in real-time, to reconfigure its reflective properties to control the refection and steering of incoming EM waves from a transmitting source (e.g., the wireless antenna 140 of the wireless interface adapter 134 of the information handling system 100) to a receiver device 178 according to embodiments herein.

In an embodiment, each of the reconfigurable metasurface unit cells 164-1, 164-2 may include a first metasurface reconfigurable split ring 166-1, a second metasurface reconfigurable split ring 166-2, and a third metasurface reconfigurable split ring 166-3. In an embodiment, each of the metasurface reconfigurable split rings 166-1, 166-2, 166-3 may be made of a non-volatile phase change material and a conductive bridge to complete each split ring. This phase change material may include, for example, germanium telluride (GeTe), antimony telluride (SbTe), or chalcogenide (GeSbTe) among other similar non-volatile phase change materials. The non-volatile phase change material of the metasurface reconfigurable split rings 166-1, 166-2, 166-3 may have two distinct states: an amorphous state and a crystalline state. In an embodiment, when the non-volatile phase change materials are in an amorphous state, the metasurface reconfigurable split rings 166-1, 166-2, 166-3 have a high resistance for a dielectric state. In an embodiment, when the non-volatile phase change materials are in a crystalline state, the metasurface reconfigurable split rings 166-1, 166-2, 166-3 may have a low resistance for a conductive state. In an embodiment, switching between the amorphous state and the crystalline state may be achieved via application of thermal energy from one of a plurality of first refractory heater 168-1, second refractory heater 168-2, and third refractory heater 168-3 corresponding to each metasurface reconfigurable split ring 166-1, 166-2, 166-3 described herein. In an embodiment, the non-volatile phase change materials may hold a state as long as it is not actuated with another heat pulse to transition to the alternate state as either the amorphous state or the crystalline state.

In an embodiment, each of the metasurface reconfigurable split rings 166-1, 166-2, 166-3 may be selectively switched from a conductive state to an dielectric state in order to modify constructive and/or destructive interference of the metasurface reconfigurable split rings 166-1, 166-2, 166-3 with the center conductive node and outer conductive ring on the incoming EM wave thereby reflectively steering the EM wave in a specific direction such as in the direction of the receiver device 178. Via the use of the constructive and/or destructive interference, any number of EM wave beam directions may be created that may be used to increase the feed distance of the EM wave beams in order to expand radiofrequency signal range or focus the directionality of the EM wave beams for the radiofrequency signals in an radiofrequency environment. In an embodiment, the directionality and feed distance of the EM wave beams may be changed (e.g., the array of reconfigurable metasurface unit cells 164-1, 164-2 may be reconfigured) within sub-milliseconds such that data may be transmitted to various different locations within an area.

As described in embodiments herein, each of the reconfigurable metasurface unit cells 164-1, 164-2 may include a first refractory heater 168-1, a second refractory heater 168-2, and a third refractory heater 168-3 to, each, selectively apply heat pulses to the first metasurface reconfigurable split ring 166-1, the second metasurface reconfigurable split ring 166-2, and the third metasurface reconfigurable split ring 166-3, respectively. In an embodiment, each of the refractory heaters 168-1, 168-2, 168-3 may be made of tungsten (W). In an embodiment, the first metasurface reconfigurable split ring 166-1, the second metasurface reconfigurable split ring 166-2, and the third metasurface reconfigurable split ring 166-3 are formed into a first layer with the first refractory heater 168-1, the second refractory heater 168-2, and the third refractory heater 168-3 formed into a second layer and electrically insulated. In an embodiment, the first layer is separated from the second layer by a dielectric layer made of, for example, silicon nitride (SiNx) or aluminum nitride (AlN). This dielectric layer may act as an electric insulator that prevents the flow of electric current from the refractory heaters 168-1, 168-2, 168-3 but be thermally conductive.

In an embodiment, each of the refractory heaters 168-1, 168-2, 168-3 are operatively coupled to a contact pad 170. The contact pads 170 may serve as a contact pad through which a metasurface PMU 172, as controlled with metasurface controller 187 may provide power to each of the refractory heaters 168-1, 168-2, 168-3 to generate heat pulses for each of the respective reconfigurable metasurface unit cells 164-1, 164-2. In an embodiment, additional layers may be formed below the refractory heaters 168-1, 168-2, 168-3. In an embodiment, these layers may include an electrical dielectric substrate made of, for example, high-resistivity silicon (HRSi), aluminum oxide (Al₂O₃), glass, or printed circuit board among others placed below the second layer. These layers may be thermally insulative. In an embodiment, a metallization layer used as a radio frequency (RF) ground may be placed below the electrical dielectric substrate and may be made of copper or other metal. Another dielectric layer made of, for example, silicon dioxide (SiO₂) may be placed below the metallization layer and above the contact pads 170. Thus, in an embodiment, a number of vias are formed through the electrical dielectric substrate, the metallization layer with isolation, and the dielectric layer below the refractory heaters 168-1, 168-2, 168-3 so that the contact pads 170 may be operatively coupled to the refractory heaters 168-1, 168-2, 168-3 via one or more metal interconnects.

In an embodiment, each of the reconfigurable metasurface unit cells 164-1, 164-2 may include other structures used to redirect transmitted EM waves and beam steer those EM waves in a desired direction. In an example embodiment, the reconfigurable metasurface unit cells 164-1, 164-2 may each include a non-reconfigurable metal fixed outer ring formed around the metasurface reconfigurable split rings 166-1, 166-2, 166-3 described herein. The non-reconfigurable metal fixed outer ring may form a passive conductive ring such that it does not require power from the metasurface PMU 172 to maintain its characteristics to contribute to the redirection of the transmitted EM waves and beam steering of those EM waves in a desired direction. In an embodiment, along with the non-reconfigurable metal fixed outer ring, each of the non-reconfigurable metal fixed split ring unit cells 164-1, 164-2 may also include a non-reconfigurable metal fixed center node formed within each of the first metasurface reconfigurable split ring 166-1 of each reconfigurable metasurface unit cell 164-1, 164-2 to also act as a passive conductive dot or pad such that it does not require power from the metasurface PMU 172 to maintain its characteristics to contribute to the redirection of the transmitted EM waves and beam steering of those EM waves in a desired direction.

As described herein, the reconfigurable metasurface unit cell array 162 may be operatively coupled to a metasurface PMU 172 and controlled via a metasurface controller 187 that may be a field programmable gate array (FPGA) circuit microchip or other hardware controller at the reconfigurable metasurface unit cell array 162. Like the PMU 128 of the information handling system 100, the metasurface PMU 172 may include control from the metasurface controller 187 to provide power to each of the refractory heaters 168-1, 168-2, 168-3 for triggered heat pulses via one or a combination of both a metasurface battery 174 and metasurface A/C power adapter 176. In an embodiment, the power needed to operate the reconfigurable metasurface unit cell array 162 may be low such that the metasurface battery 174 may be sufficient to pulse heat to the individual refractory heaters 168-1, 168-2, 168-3 in order to switch the metasurface reconfigurable split rings 166-1, 166-2, 166-3 from an amorphous state to a crystalline state or vice versa.

By switching each of the metasurface reconfigurable split rings 166-1, 166-2, 166-3 between the amorphous state and the crystalline state, the reconfigurable metasurface unit cell array 162 may be configured to redirect transmitted EM waves and beam steer those EM waves in a desired direction and may be controlled via the metasurface controller 187. Additionally, because the heating of the phase change material of the metasurface reconfigurable split rings 166-1, 166-2, 166-3 can be achieved by applying thermal energy such as a pulse with a certain amplitude and width (on the order of nanoseconds) through the electrically insulated high-speed, refractory heaters 168-1, 168-2, 168-3, the constant application of power is not needed thereby reducing the need for a dedicated power source. Indeed, in some embodiments, these phase change materials of the metasurface reconfigurable split rings 166-1, 166-2, 166-3 hold their states as long as it is not actuated with another heat pulse to change to the other crystalline or amorphous phase.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

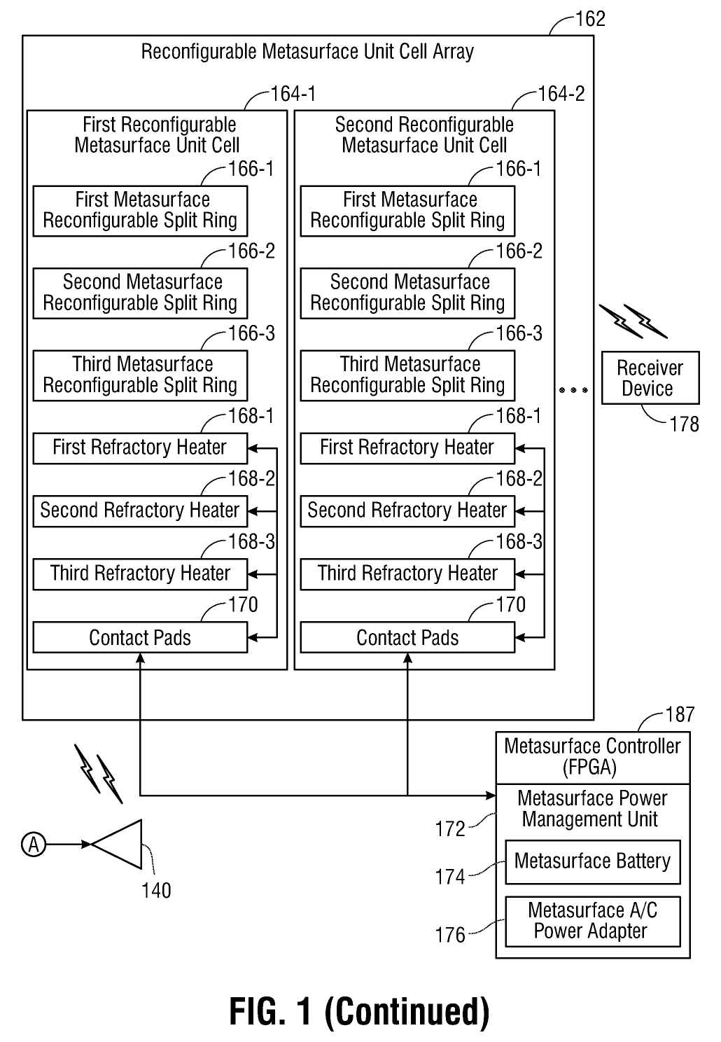

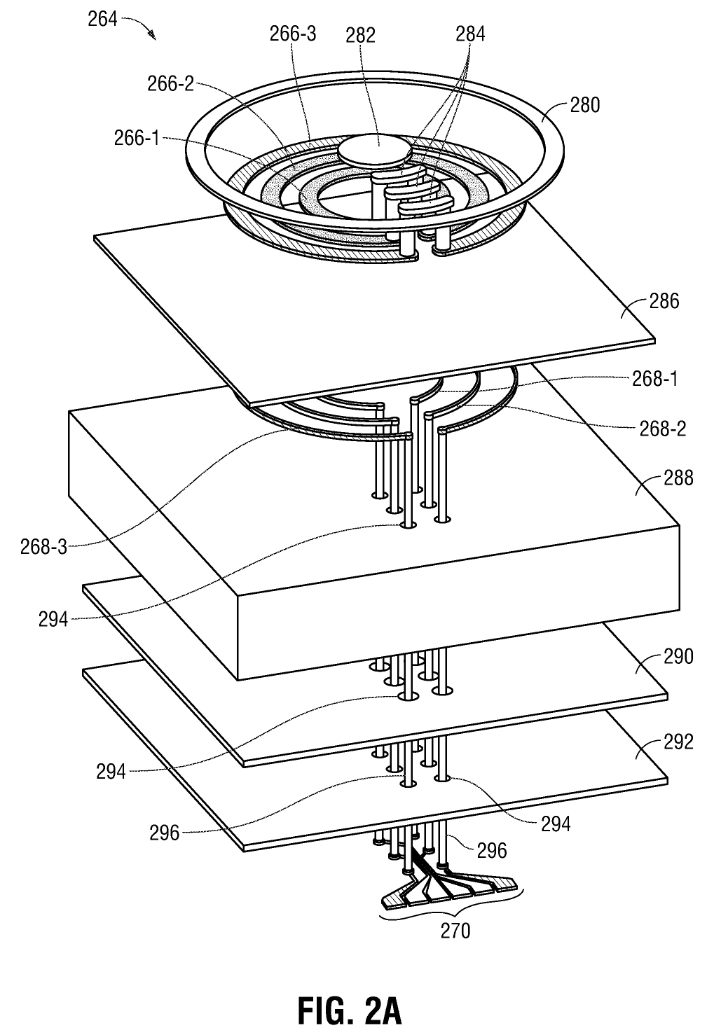

FIG. 2A is an exploded graphic diagram perspective view illustrating a reconfigurable metasurface unit cell 264 of a reconfigurable metasurface unit cell array (e.g., FIG. 1,162) according to an embodiment of the present disclosure. Additionally, FIG. 2B is a side, exploded graphic diagram cross-section illustrating a reconfigurable metasurface unit cell 264 of a reconfigurable metasurface unit cell array according to another embodiment of the present disclosure. It is appreciated that each of the reconfigurable metasurface unit cells 264 of the reconfigurable metasurface unit cell array may comprise their own various layers or may, in an embodiment, share the same layer or layers. Again, the reconfigurable metasurface unit cell 264 shown in FIGS. 2A and 2B may be one of a plurality of reconfigurable metasurface unit cells 264 that form the reconfigurable metasurface unit cell array and may include any number of reconfigurable metasurface unit cells 264 arranged in any manner forming a two-dimensional structure.

As shown in FIGS. 2A and 2B, the reconfigurable metasurface unit cell 264 includes concentrically formed first metasurface reconfigurable split ring 266-1, second metasurface reconfigurable split ring 266-2, and third metasurface reconfigurable split ring 266-3 on a first layer of the reconfigurable metasurface unit cell 264. Each of these metasurface reconfigurable split rings 266-1, 266-2, 266-3 may include any phase change materials such as GeTe, SbTe, or GeSbTe among other similar non-volatile phase change materials and a conductive bridge 284 to complete the ring. The metasurface reconfigurable split rings 266-1, 266-2, 266-3 share the same layer as the non-reconfigurable metal fixed ring 280, arranged as an outer ring in some embodiments or another location in other embodiments, and non-reconfigurable metal fixed center node 282. These metasurface reconfigurable split rings 266-1, 266-2, 266-3, the non-reconfigurable metal fixed ring 280, and non-reconfigurable metal fixed center node 282 act together to control and focus the directionality of the EM wave beams reflected off of the reconfigurable metasurface unit cell array. In an embodiment, the non-reconfigurable metal fixed ring 280 and non-reconfigurable metal fixed center node 282 may be made of a metal such as gold (Au), copper (Cu), aluminum (Al), nickel (Ni) among other types of conductive metals.

In an embodiment, each of the metasurface reconfigurable split rings 266-1, 266-2, 266-3 may include a split or gap along the circumference of the metasurface reconfigurable split rings 266-1, 266-2, 266-3. As shown in FIG. 2A, for example, this gap correlates with a gap in each of the respective refractory heaters 268-1, 268-2, 268-3 formed below the first layer formed by the metasurface reconfigurable split rings 266-1, 266-2, 266-3 and a first dielectric layer 286. This enables operation of the refractory heaters 268-1, 268-2, 268-3 to pulse heat to the phase change material of the metasurface reconfigurable split rings 266-1, 266-2, 266-3. In order to maintain the active beam steering capabilities of each of the metasurface reconfigurable split rings 266-1, 266-2, 266-3, this gap in each metasurface reconfigurable split rings 266-1, 266-2, 266-3 may be bridged using a conductive bridge 284. The conductive bridge 284 allows for induced currents in each of the metasurface reconfigurable split rings 266-1, 266-2, 266-3 to create or adjust radiated fields that form the controllable reflected wave patterns described herein.

Below this first layer comprised of the metasurface reconfigurable split rings 266-1, 266-2, 266-3, the non-reconfigurable metal fixed ring 280, and the non-reconfigurable metal fixed center node 282, the reconfigurable metasurface unit cell 264 includes a first dielectric layer 286. This first dielectric layer 286 may be made of SiNx of AlN. In an embodiment, this first dielectric layer 286 may include any insulating substance that does not conduct electricity, but may also support electrostatic fields created during operation of the reconfigurable metasurface unit cell 264. Further, the first dielectric layer 286 may facilitate heat conduction between the refractory heaters 268-1, 268-2, 268-3 and the respective metasurface reconfigurable split rings 266-1, 266-2, 266-3.

Below the first dielectric layer 286, a second layer may be formed that comprises the first refractory heater 268-1, the second refractory heater 268-2, and the third refractory heater 268-3. The refractory heaters 268-1, 268-2, 268-3 may each, individually and selectively, heat their respective metasurface reconfigurable split ring 266-1, 266-2, 266-3 with high intensity short duration pulses of heat. Thus, when a power source is applied to the first refractory heater 268-1, the first refractory heater 268-1 heats the first metasurface reconfigurable split ring 266-1. Additionally, when the power source is applied to the second refractory heater 268-2, the second refractory heater 268-2 heats the second metasurface reconfigurable split ring 266-2. Further, when a power source is applied to the third refractory heater 268-3, the third refractory heater 268-3 heats the third metasurface reconfigurable split ring 266-3. Thus, the states of each of the metasurface reconfigurable split rings 266-1, 266-2, 266-3 may be individual controlled via pulse heating of the individual refractory heaters 268-1, 268-2, 268-3 such that the states of the metasurface reconfigurable split rings 266-1, 266-2, 266-3 may be switched from their amorphous states to their crystalline states or vice versa.

It is appreciated that the voltage and current applied to each of the refractory heaters 268-1, 268-2, 268-3 controls the states of the metasurface reconfigurable split rings 266-1, 266-2, 266-3. For example, where the voltage applied to any of the refractory heaters 268-1, 268-2, 268-3 is high (e.g., 15-20 V) for a short period of time (e.g., up to 0.5 microseconds (µs)) with a peak current of 300 to 310 mA, the metasurface reconfigurable split rings 266-1, 266-2, 266-3 are placed in an amorphous state. This application of this voltage at this current creates a peak temperature at a metasurface reconfigurable split ring 266-1, 266-2, 266-3 of 700 to 800 ºC. An average pulse power (W) may be initiated pulse heat to transition the phase change material the crystalline state at between 10⁰ Ω 10¹ Ω and to the amorphous state between 10⁵ Ω 10⁶ Ω in order to transition from a conductive state to the dielectric state in this example. However, where the voltage applied to any of the refractory heaters 268-1, 268-2, 268-3 is relatively lower (e.g., 9-10 V) for a relatively longer period of time (e.g., 2 µs) with a peak current of 210 to 220 mA the metasurface reconfigurable split rings 266-1, 266-2, 266-3 are switched back to a crystalline state in an embodiment. This application of this voltage and current creates a peak temperature at a metasurface reconfigurable split ring 266-1, 266-2, 266-3 of 400 to 410 ºC. It is appreciated that heat pulses needed in order to place the non-volatile phase change material of the metasurface reconfigurable split rings 266-1, 266-2, 266-3 into an amorphous state or a crystalline state depends on the type of non-volatile phase change material used. Thus, the electrical pulse from the metasurface PMU (e.g., FIG. 1, 172) at an applied voltage and current to each of the refractory heaters 268-1, 268-2, 268-3 to change the state of the non-volatile phase change material of each metasurface reconfigurable split ring 266-1, 266-2, 266-3 may depend on the type of non-volatile phase change material used. The present specification contemplates that any of a plurality of non-volatile phase change materials may be used necessitating changes in these applied voltages and currents.

Other layers and substrates may also be included in the stack within the reconfigurable metasurface unit cell 264. In an example embodiment, the reconfigurable metasurface unit cell 264 may further include an electrical dielectric substrate 288 placed below the second layer that comprises the refractory heaters 268-1, 268-2, 268-3. This electrical dielectric substrate 288 may be made of a HRSi, Al₂O₃, glass, or PCB among other dielectric materials. In an embodiment, the first dielectric layer 286 and electrical dielectric substrate 288 may electrically isolate the refractory heaters 268-1, 268-2, 268-3 from the remaining portions of the reconfigurable metasurface unit cell 264.

In an embodiment, a metallization layer 290 may be formed below the electrical dielectric substrate 288. This metallization layer 290 may be made of Au, Cu, Al, or Ni among other types of metals. In an embodiment, this metallization layer 290 may serve as an RF grounding source for the reconfigurable metasurface unit cell 264.

In an embodiment, a second dielectric layer 292 may be placed below the metallization layer 290. This second dielectric layer 292 may be made of silicon dioxide (SiO₂). Similar to the first dielectric layer 286, the second dielectric layer 292 may also support electrostatic fields created during the operation of the unit cell 264. In other embodiments, the second dielectric layer 292 may have limited thermal conductivity.

Below the second dielectric layer 292, the contact pads 270 used to electrically couple the refractory heaters 268-1, 268-2, 268-3 to a metasurface PMU (e.g., FIG. 1172) is shown. The contact pads 270 may be made of any conductive metal such as Au, Cu, Al, or Ni among other types of metals. The contact pads 270 may receive those electrical pulses from the metasurface PMU in order to pulse heat, individually, each of the refractory heaters 268-1, 268-2, 268-3. In order to operatively couple each of the refractory heaters 268-1, 268-2, 268-3 to a respective contact pad 270, a plurality of metal interconnect layers 296 are formed. In the example embodiment shown in FIGS. 2A and 2B, the metal interconnect layers 296 couple a contact pad to each terminal end of each of the refractory heaters 268-1, 268-2, 268-3. In order to do so, one or more vias 294 are formed through, at least, the second dielectric layer 292, the metallization layer 290, and the electrical dielectric substrate 288 so that the metal interconnect layers 296 may pass from each of the respective contact pads 270 to their respective refractory heaters 268-1, 268-2, 268-3.

FIGS. 2A and 2B show a single reconfigurable metasurface unit cell 264 among a plurality of reconfigurable metasurface unit cells 264 that may form the reconfigurable metasurface unit cell array. It is appreciated that the reconfigurable metasurface unit cell array may comprise any number of individually activatable reconfigurable metasurface unit cells 264. In one example embodiment, the reconfigurable metasurface unit cell array may place the reconfigurable metasurface unit cells 264 in a row and column orientation thereby forming, for example, a sixteen-by-sixteen reconfigurable metasurface unit cell array. During operation, as described herein, each refractory heaters 268-1, 268-2, 268-3 are individually heated using the contact pads 270 such that each of the metasurface reconfigurable split rings 266-1, 266-2, 266-3, individually, undergo a phase change into an amorphous state or a crystalline state thereby changing the EM wave reflective properties of each individual unit cell 264 and allowing plural EM wave directions to be controlled with the reconfigurable metasurface unit cells 264 in the array. By selectively changing the individual EM wave reflective properties of each individual unit cell 264, the reconfigurable metasurface unit cell array may also change the directionality and feed distance of the reflected EM wave such that the reconfigurable metasurface unit cell array may direct the EM wave to a specific location and/or receiving device (e.g., FIG. 1, 178). Because of the reflective directionality of the reconfigurable metasurface unit cell array may be changed readily (e.g., in the order of microseconds or nanoseconds), a single reconfigurable metasurface unit cell array may be reconfigured to relay data in radiofrequency signals via these EM waves to multiple receiving devices. Thus, in an environment where 5G or other EM waves are being relayed, the presently-described reconfigurable metasurface unit cell array may relay radiofrequency signal data around corners or along long distances in a radiofrequency environment in order to transmit that data to the appropriate receiving device.

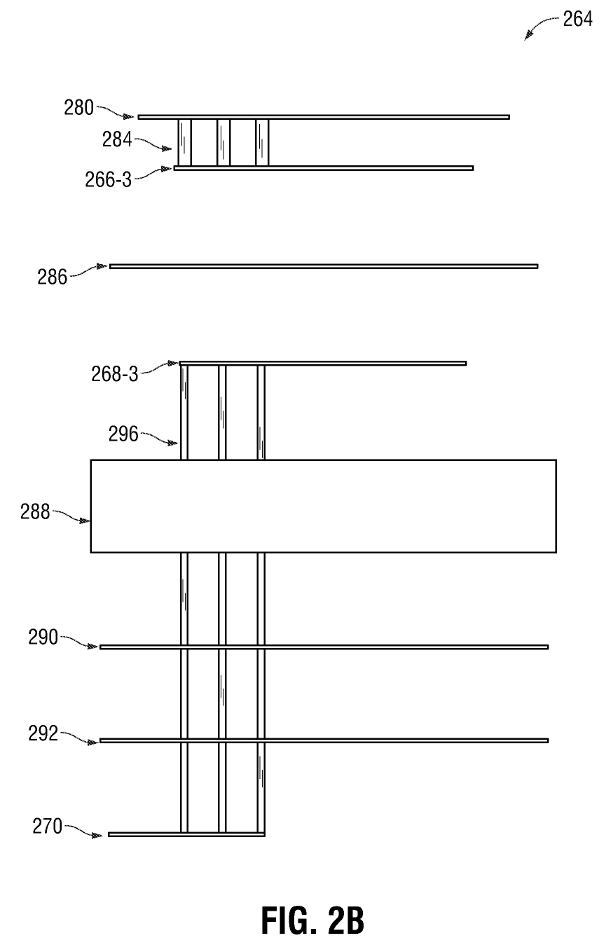

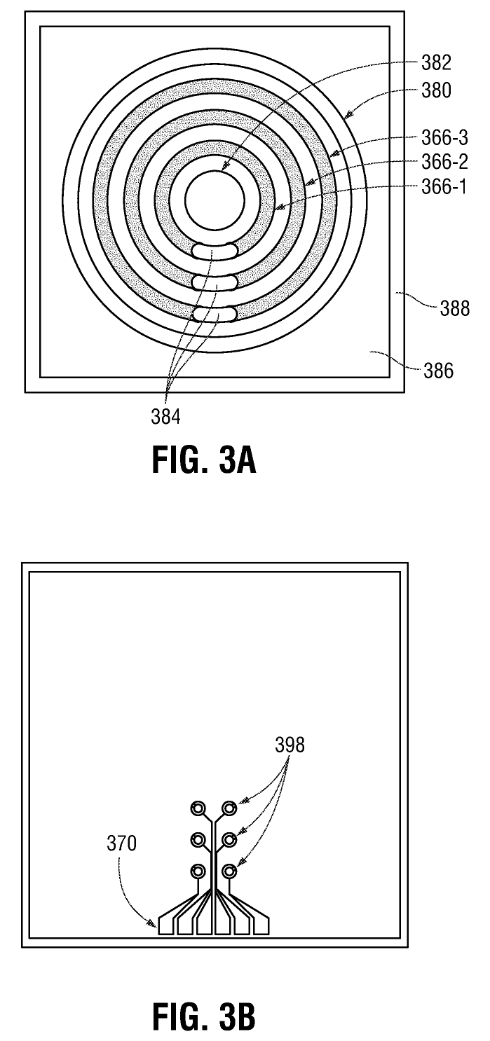

FIG. 3A is a top view graphic diagram showing a plurality of metasurface reconfigurable rings 366-1, 366-2, 366-3 of a reconfigurable metasurface unit cell (e.g., FIG. 2A,264) according to an embodiment of the present disclosure. Additionally, FIG. 3B is a top view diagram showing a plurality of contact pads 370 of a reconfigurable metasurface unit cell according to an embodiment of the present disclosure. FIG. 3A shows the first dielectric layer 386 and electrical dielectric substrate 388 showing that these two layers reside below the first layer that comprises the first metasurface reconfigurable split ring 366-1, the second metasurface reconfigurable split ring 366-2, the third metasurface reconfigurable split ring 366-3, the non-reconfigurable metal fixed ring 380, and the non-reconfigurable metal fixed center node 382. Although the non-reconfigurable metal fixed ring 380 is shown as an outer ring of the reconfigurable metasurface unit cell, it is contemplated that the reconfigurable metasurface unit cell may have the non-reconfigurable metal fixed ring 380 as any ring in the sequence of concentric plurality of metasurface reconfigurable rings 366-1, 366-2, 366-3 in various embodiments. Further, although a circular shape is shown for the plurality of metasurface reconfigurable rings 366-1, 366-2, 366-3 and the non-reconfigurable metal fixed ring 380, other concentric shapes are contemplated and may be implemented according to embodiments of the present disclosure including oval shapes, any geometric shapes, irregular shapes, or a mix of concentric shapes in various embodiments herein.

As described herein, each of these metasurface reconfigurable split rings 366-1, 366-2, 366-3 may include any phase change materials such as GeTe, SbTe, or GeSbTe among other similar non-volatile phase change materials. The metasurface reconfigurable split rings 366-1, 366-2, 366-3 share the same layer as the non-reconfigurable metal fixed ring 380 and non-reconfigurable metal fixed center node 382 and act together to focus the directionality of the EM wave beams reflected off of the reconfigurable metasurface unit cell array. In an embodiment, the non-reconfigurable metal fixed ring 380 and non-reconfigurable metal fixed center node 382 may be made of a metal such as gold (Au), copper (Cu), aluminum (Al), nickel (Ni) among other types of conductive metals.

In an embodiment, each of the metasurface reconfigurable split rings 366-1, 366-2, 366-3 may include a split or gap along the circumference of the metasurface reconfigurable split rings 366-1, 366-2, 366-3. As shown in FIG. 2A, for example, this gap correlates with a gap in each of the respective refractory heaters (e.g., FIG. 2A,268-1,268-2,268-3) formed below the first layer formed by the metasurface reconfigurable split rings 366-1, 366-2, 366-3 and a first dielectric layer 386. In order to complete the ring or other shaped structure each of the metasurface reconfigurable split rings 366-1, 366-2, 366-3, this gap in each metasurface reconfigurable split rings 366-1, 366-2, 366-3 may be bridged using its own conductive bridge 384. The conductive bridges 384 allow for induced currents in each of the metasurface reconfigurable split rings 366-1, 366-2, 366-3 to create radiated fields that form the reflected wave patterns and control of directionality of those radiofrequency signals as described herein.

It is appreciated that each of the terminal ends of each refractory heater structure corresponding to each of the metasurface reconfigurable rings 366-1, 366-2, 366-3 may be operatively coupled to a contact pad 370 via one or more contact pad leads 398 as shown in FIG. 3B. The contact pad leads 398 may be placed directly below each terminal end of each refractory heater structure corresponding to each of metasurface reconfigurable ring 366-1, 366-2, 366-3 such that the vias may be formed through the various layers of the reconfigurable metasurface unit cell with the metal interconnect layers (e.g., FIG. 2,296) operatively coupling each contact pad lead 398 to their respective terminal end of each refractory heater structure corresponding to each metasurface reconfigurable ring 366-1, 366-2, 366-3. FIG. 3B also shows an example arrangement of each of the contact pads 370 and contact pad leads 398 such that a metasurface PMU may provide the necessary electrical pulses to each refractory heater structure corresponding to each of the metasurface reconfigurable rings 366-1, 366-2, 366-3 as described herein.

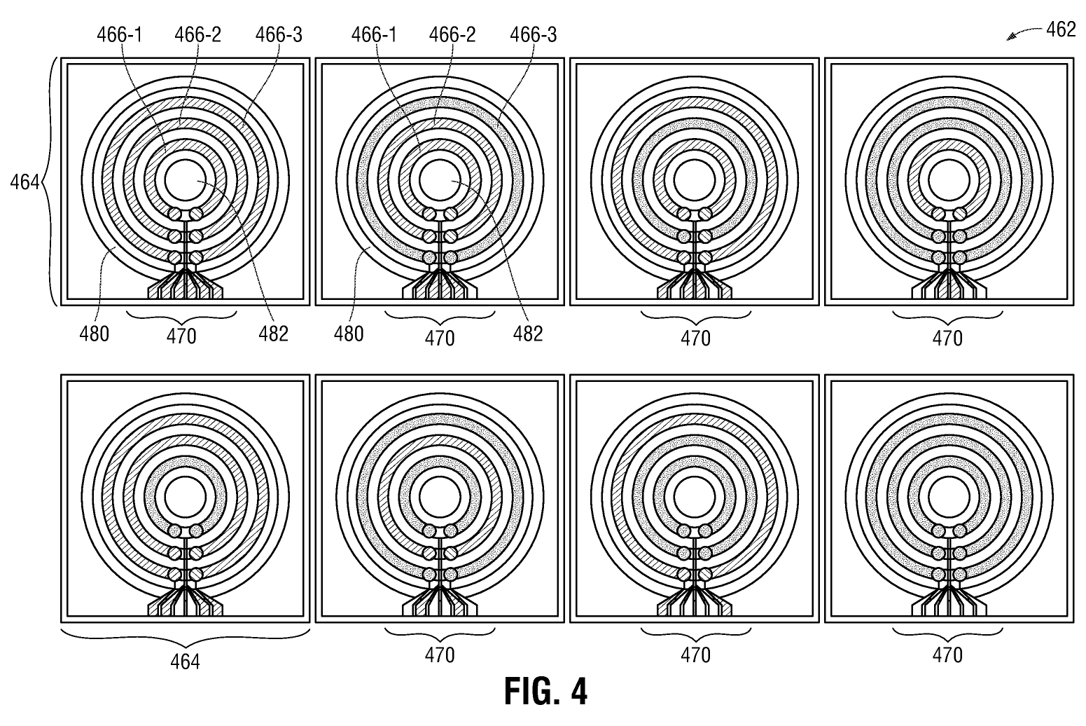

FIG. 4 is a top view of a plurality of reconfigurable metasurface unit cells 464 of a reconfigurable metasurface unit cell array 462 depicting various activation states of the plurality of reconfigurable metasurface unit cells 464 according to an embodiment of the present disclosure. It is appreciated that although FIG. 4 shows a reconfigurable metasurface unit cell array 462 having a four by two unit cell 464 arrangement, this may represent only a portion of a reconfigurable metasurface unit cell array 462. The present specification contemplates that the reconfigurable metasurface unit cell array 462 may include more or fewer unit cells 464 than those shown in FIG. 4. In an embodiment, the reconfigurable metasurface unit cell array 462 may be an array of sixteen unit cells 464 by sixteen reconfigurable metasurface unit cells 464. It is also appreciated that although for purposes of description, FIG. 4 is described with respect to the various elements of the reconfigurable metasurface unit cells 464 in the top-left two unit cells 464, the other reconfigurable metasurface unit cells 464 depicted in FIG. 4 include similar elements and operation as described in FIG. 4.

Again, each reconfigurable metasurface unit cell 464 may include a first metasurface reconfigurable split ring 466-1, a second metasurface reconfigurable split ring 466-2, and a third metasurface reconfigurable split ring 466-3. Each of these metasurface reconfigurable split rings 366-1, 366-2, 366-3 may include any phase change materials such as GeTe, SbTe, or GeSbTe among other similar non-volatile phase change materials. The metasurface reconfigurable split rings 366-1, 366-2, 366-3 share the same layer as the non-reconfigurable metal fixed ring 380 and non-reconfigurable metal fixed center node 382 and act together to focus the directionality of the EM wave beams reflected off of the reconfigurable metasurface unit cell array according to embodiments herein. In an embodiment, the non-reconfigurable metal fixed ring 380 and non-reconfigurable metal fixed center node 382 may be made of a metal such as Au, Cu, Al, Ni among other types of conductive metals.

As shown in FIG. 4, the top left unit cell 464 shows that all three of the metasurface reconfigurable rings 466-1, 466-2, 466-3 have been placed in an amorphous state. This is indicated by the hash fill of these elements indicating, in this example embodiment, that these metasurface reconfigurable rings 466-1, 466-2, 466-3 have been placed in the amorphous state and are non-conductive. Again, these states in each of the metasurface reconfigurable rings 466-1, 466-2, 466-3 are achieved and individually controlled via pulse heating of the individual refractory heaters (not shown) such that the states of the metasurface reconfigurable rings 466-1, 466-2, 466-3 may be switched from their amorphous states to their crystalline states or vice versa.

FIG. 4 shows that a neighboring reconfigurable metasurface unit cell 464 to the immediate right of the left-most upper unit cell 464 has two of the metasurface reconfigurable rings 466-1 and 466-2 that have been placed in the amorphous state while another metasurface reconfigurable ring 466-3 has been placed in the crystalline state. In this example, the first metasurface reconfigurable split ring 466-1 and second metasurface reconfigurable split ring 466-2 have been placed in the amorphous state indicated by the hash fill and which is non-conductive while the third metasurface reconfigurable split ring 466-3 has been placed in the crystalline state which is conductive as indicated by the dotted fill for this element. Again, it is appreciated that the pulse of voltage and current applied to each of the refractory heaters controls the states of the metasurface reconfigurable rings 466-1, 466-2, 466-3. For example, where the voltage applied to any of the refractory heaters is high (e.g., 15-20 V) for a short period of time (e.g., up to 0.5 µs) with a peak current of 300 to 310 mA, the metasurface reconfigurable rings 466-1, 466-2, 466-3 are placed in an amorphous state as shown in the first metasurface reconfigurable split ring 466-1 and second metasurface reconfigurable split ring 466-2. This application of this voltage at this current creates a peak temperature at the first metasurface reconfigurable split ring 466-1 and second metasurface reconfigurable split ring 466-2 of 700 to 800 ºC in order to transition from the crystalline state to this amorphous state in this example. Such a heat pulse may change the first metasurface reconfigurable split ring 466-1 and the second metasurface reconfigurable split ring 466-2 as described.

However, where the voltage applied to any of the refractory heaters is relatively lower (e.g., 9-10 V) for a relatively longer period of time (e.g., 2 µs) with a peak current of 210 to 220 mA the metasurface reconfigurable split rings 466-1, 466-2, 466-3 are placed in a crystalline state such as that shown in the third metasurface reconfigurable split ring 466-3. This application of this voltage at this current creates a peak temperature at the third metasurface reconfigurable split ring 466-3 of 400 to 410 ºC in order to transition from the amorphous state to this crystalline state in a second example as may be shown in the difference of activated metasurface reconfigurable rings 466-1, 466-2 between the two top row neighboring reconfigurable metasurface unit cells 464. It is appreciated that in order to place the non-volatile phase change material of the metasurface reconfigurable rings 466-1, 466-2, 466-3 into an amorphous state or a crystalline state depends on the type of non-volatile phase change material used. Thus, the electrical pulse from the metasurface PMU (e.g., FIG. 1,172) at an applied voltage and current to each of the refractory heaters to change the state of the non-volatile phase change material of each metasurface reconfigurable rings 466-1, 466-2, 466-3 may depend on the type of non-volatile phase change material used and the present specification contemplates that other non-volatile phase change materials may be used necessitating changes in these applied voltages and currents.

Because each of the individual reconfigurable metasurface unit cells 464 shown in FIG. 4 may be individually tuned such that each of the individual metasurface reconfigurable rings 466-1, 466-2, 466-3 can be changed from an amorphous state to a crystalline state or vice versa, the EM wave reflection properties of the reconfigurable metasurface unit cell array 462 may be changed in each reconfigurable metasurface unit cell 464 and across the reconfigurable metasurface unit cell array to direct or focus receipt or reflection of radiofrequency signals between a source wireless information handling system and a target wireless information handling system. In an embodiment, the amorphous state or crystalline state of some metasurface reconfigurable rings 466-1, 466-2, 466-3 may be changed such that each individual unit cell 464 may engage in constructive or destructive interference. This constructive or destructive interference may contribute, as whole, to the beam forming capabilities of the reconfigurable metasurface unit cell array 462 thereby allowing for an increase or decrease in feed distance of the reflected EM waves, and or higher or lower power distribution plane distance across the surface of the reconfigurable metasurface unit cell array 462 in order to adjust directionality lobes of EM wave reflection and distribution of radiofrequency signals between source and target wireless devices in a radiofrequency environment.

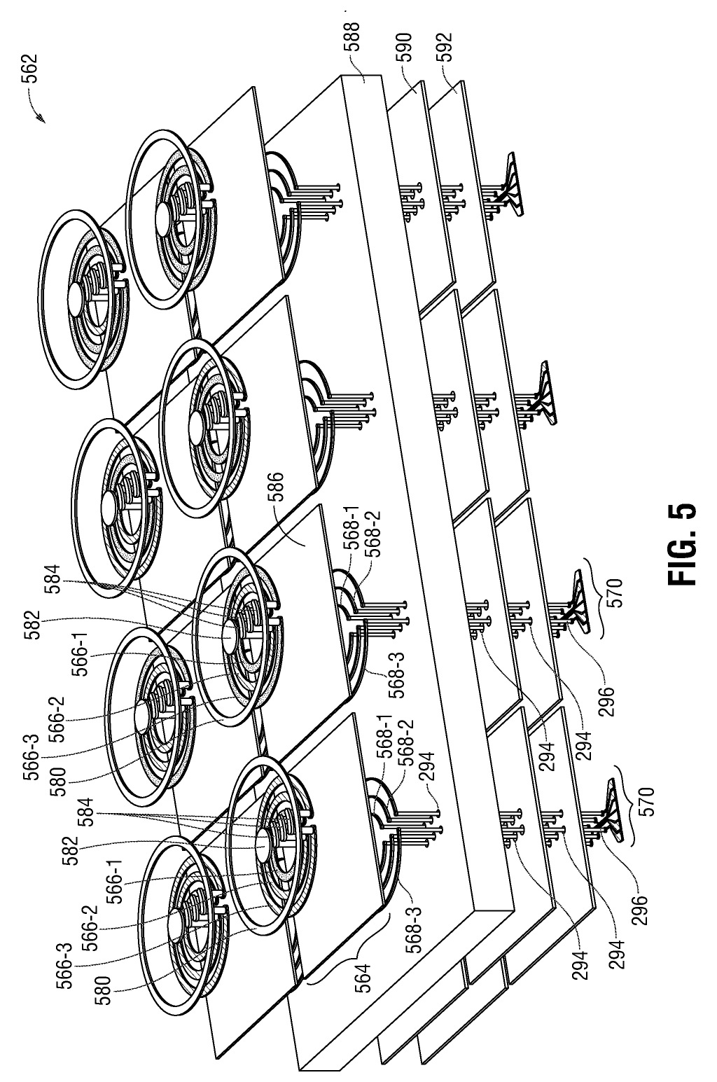

FIG. 5 is a graphic diagram showing an exploded perspective view of the reconfigurable metasurface unit cell array according to an embodiment of the present disclosure. In this example, FIG. 5 is a perspective view exploded graphic diagram illustrating a plurality of unit cells 564 of a reconfigurable metasurface unit cell array 562 according to another embodiment of the present disclosure. As shown in FIG. 5, each reconfigurable metasurface unit cell 564 may include a staking of various elements similar to those presented in FIG. 2A for example. It is appreciated that each of the reconfigurable metasurface unit cells 564 of the reconfigurable metasurface unit cell array 562 may comprise their own various layers or may, in an embodiment, share the same layer or layers within the array. Again, the reconfigurable metasurface unit cell 564 shown in FIG. 5 may one of a plurality of unit cells 564 that form the reconfigurable metasurface unit cell array 562 and may include any number of unit cells 564 arranged in any manner on a two-dimensional plane. In an embodiment, the reconfigurable metasurface unit cell array 562 may be an array of sixteen unit cells 564 by sixteen unit cells 564. It is also appreciated that although FIG. 5 shows the various elements of the plurality of reconfigurable metasurface unit cells 564, for purposes of discussion the bottom-left two reconfigurable metasurface unit cells 564 are discussed, however, the other unit cells 564 depicted in FIG. 5 include similar elements and operation as described in FIG. 5.

As shown in FIG. 5, the reconfigurable metasurface unit cells 564 include concentrically formed first metasurface reconfigurable split ring 566-1, second metasurface reconfigurable split ring 566-2, and third metasurface reconfigurable split ring 566-3 on a first layer of the reconfigurable metasurface unit cell 564. Each of these metasurface reconfigurable split rings 566-1, 566-2, 566-3 may include any phase change materials such as GeTe, SbTe, or GeSbTe among other similar non-volatile phase change materials. The metasurface reconfigurable split rings 566-1, 566-2, 566-3 share the same layer as the non-reconfigurable metal fixed ring 580 and non-reconfigurable metal fixed center node 582 and act together to focus (e.g., increase or decrease the feed distance) the directionality (e.g., beam steering) of the EM wave beams reflected off of the reconfigurable metasurface unit cell array 562 as described in embodiments herein. In an embodiment, the non-reconfigurable metal fixed ring 580 and non-reconfigurable metal fixed center node 582 may be made of a metal such as Au, Cu, Al, Ni among other types of conductive metals. It is appreciated that the metasurface reconfigurable rings 566-1, 566-2, 566-3, the non-reconfigurable metal fixed ring 580, and the non-reconfigurable metal fixed center node 582 may be formed onto the same layer and may be referred to herein as a first layer of any given unit cell 564.

In an embodiment, each of the metasurface reconfigurable split rings 566-1, 566-2, 566-3 may include a split or gap along the circumference of the metasurface reconfigurable split rings 566-1, 566-2, 566-3. As shown in FIG. 5, for example, this gap correlates with a gap in each of the respective refractory heaters 568-1, 568-2, 568-3 formed below the first layer so the refractory heaters 568-1, 568-2, 568-3 may operate. In order, however, to complete a conductive ring structure when phase change material is in a conductive state of each of the metasurface reconfigurable split rings 566-1, 566-2, 566-3, this gap in each metasurface reconfigurable split rings 566-1, 566-2, 566-3 may be bridged using a conductive bridge 584. The conductive bridge 584 allows for induced currents in each of the metasurface reconfigurable split rings 566-1, 566-2, 566-3 to create radiated fields that form the reflected wave patterns described in embodiments herein.

Below this first layer comprised of the metasurface reconfigurable split rings 566-1, 566-2, 566-3, the non-reconfigurable metal fixed ring 580, and the non-reconfigurable metal fixed center node 582, the reconfigurable metasurface unit cell 564 includes a first dielectric layer 586. This first dielectric layer 586 may be made of SiNx of AlN. In an embodiment, this first dielectric layer 586 may include any insulating substance that does not conduct electricity, but may also support electrostatic fields created during operation of the reconfigurable metasurface unit cell 564. This first dielectric layer 586 may still be thermally conductive however in embodiments herein. In an embodiment, the first dielectric layer 586 may be shared among all unit cells 564 within the reconfigurable metasurface unit cell array 562. In another embodiment shown in FIG. 5, each reconfigurable metasurface unit cell 564 has its own dedicated first dielectric layer 586.

Below the first dielectric layer 586, a second layer may be formed that comprise the first refractory heater 568-1, the second refractory heater 568-2, and the third refractory heater 568-3. The refractory heaters 568-1, 568-2, 568-3 may each, individually and selectively, heat their respective metasurface reconfigurable split ring 566-1, 566-2, 566-3. Thus, when a power source is applied to the first refractory heater 568-1, the first refractory heater 568-1 heats the first metasurface reconfigurable split ring 566-1. Additionally, when the power source is applied to the second refractory heater 568-2, the second refractory heater 568-2 heats the second metasurface reconfigurable split ring 566-2. Further, when a power source is applied to the third refractory heater 568-3, the third refractory heater 568-3 heats the third metasurface reconfigurable split ring 566-3. Thus, the states of each of the metasurface reconfigurable split rings 566-1, 566-2, 566-3 may be individual controlled via heating of the individual refractory heaters 568-1, 568-2, 568-3 such that the states of the metasurface reconfigurable split rings 566-1, 566-2, 566-3 may be switched from their amorphous states to their crystalline states or vice versa. It is appreciated that the number of refractory heaters 568-1, 568-2, 568-3 shown in FIG. 5 is merely an example number of refractory heaters 568-1, 568-2, 568-3 and where the number of metasurface reconfigurable rings 566-1, 566-2, 566-3 increases beyond the three shown, a commensurate number of refractory heaters 568-1, 568-2, 568-3 may also be added to accommodate for the extra number of metasurface reconfigurable rings 566-1, 566-2, 566-3. Additionally, where the number of refractory heaters 568-1, 568-2, 568-3 increases beyond the three shown in FIG. 5, a commensurate number of contact pads 570, metal interconnect layers 596, and vias 594 are also increased to accommodate for the application of the power pulses to the additional refractory heaters 568-1, 568-2, 568-3.

It is appreciated that the voltage and current applied to each of the refractory heaters 568-1, 568-2, 568-3 controls the states of the metasurface reconfigurable split rings 566-1, 566-2, 566-3.For example, where the voltage applied to any of the refractory heaters 568-1, 568-2, 568-3 is high (e.g., 15-20 V) for a short period of time (e.g., up to 0.5 microseconds (µs)) with a peak current of 300 to 310 mA, the metasurface reconfigurable split rings 566-1, 566-2, 566-3 are transitioned to an amorphous state. This application of this voltage at this current creates a peak temperature at a metasurface reconfigurable split ring 566-1, 566-2, 566-3 of 700 to 800 ºC in order to transition from the crystalline state to this amorphous state in this example. However, where the voltage applied to any of the refractory heaters 568-1, 568-2, 568-3 is relatively lower (e.g., 9-10 V) for a relatively longer period of time (e.g., 2 µs) with a peak current of 210 to 220 mA the metasurface reconfigurable split rings 566-1, 566-2, 566-3 are transitioned to a crystalline state. This application of this voltage at this current creates a peak temperature at a metasurface reconfigurable split ring 566-1, 566-2, 566-3 of 400 to 410 ºC in order to transition from the amorphous state to this crystalline state in this example. It is appreciated that in order to place the non-volatile phase change material of the metasurface reconfigurable split rings 566-1, 566-2, 566-3 into an amorphous state or a crystalline state depends on the type of non-volatile phase change material used. Thus, the electrical pulse from the metasurface PMU (e.g., FIG. 1,172) at an applied voltage and current to each of the refractory heaters 568-1, 568-2, 568-3 to change the state of the non-volatile phase change material of each metasurface reconfigurable split ring 566-1, 566-2, 566-3 may depend on the type of non-volatile phase change material used and the present specification contemplates that other non-volatile phase change materials may be used necessitating changes in these applied voltages and currents.

Other layers and substrates may also be included in the stack within the reconfigurable metasurface unit cell 564. In an example embodiment, the reconfigurable metasurface unit cell 564 may further include an electrical dielectric substrate 588 placed below the second layer that comprises the refractory heaters 568-1, 568-2, 568-3. This electrical dielectric substrate 588 may be made of a HRSi, Al₂O₃, glass, or PCB among other dielectric materials. In an embodiment, the first dielectric layer 586 and electrical dielectric substrate 588 may electrically isolate the refractory heaters 568-1, 568-2, 568-3 from the remaining portions of the reconfigurable metasurface unit cell 564. Again, it is appreciated that each of the reconfigurable metasurface unit cells 564 of the reconfigurable metasurface unit cell array 562 may share the same layer of electrical dielectric substrate 588 as shown in FIG. 5. However, the present specification also contemplates that each reconfigurable metasurface unit cell 564 may have their own layer of electrical dielectric substrate 588 disconnected from the electrical dielectric substrates 588 of the other unit cells 564.

In an embodiment, a metallization layer 590 may be formed below the electrical dielectric substrate 588. This metallization layer 590 may be made of Au, Cu, Al, or Ni among other types of metals. In an embodiment, this metallization layer 590 may serve as an RF grounding source for the reconfigurable metasurface unit cell 564. Again, it is appreciated that each of the reconfigurable metasurface unit cells 564 of the reconfigurable metasurface unit cell array 562 may share the same layer of metallization layer 590. However, the present specification also contemplates that each reconfigurable metasurface unit cell 564 may have their own layer of metallization layer 590 disconnected from the metallization layer 590 of the other unit cells 564 as shown in FIG. 5.

In an embodiment, a second dielectric layer 592 may be placed below the metallization layer 590. This second dielectric layer 592 may be made of silicon dioxide (SiO₂). Similar to the first dielectric layer 586, the second dielectric layer 592 may also support electrostatic fields created during the operation of the reconfigurable metasurface unit cell 564. Again, it is appreciated that each of the reconfigurable metasurface unit cells 564 of the reconfigurable metasurface unit cell array 562 may share the same layer of second dielectric layer 592. However, the present specification also contemplates that each unit cell 564 may have their own layer of second dielectric layer 592 disconnected from the second dielectric layers 592 of the other unit cells 564 as shown in FIG. 5.

Below the second dielectric layer 592, the contact pads 570 used to electrically couple the refractory heaters 568-1, 568-2, 568-3 to a metasurface PMU (e.g., FIG. 1 172) are shown. The contact pads 570 may be made of any conductive metal such as Au, Cu, Al, or Ni among other types of metals. The contact pads 570 may receive those electrical pulses from the metasurface PMU in order to heat, individually, each of the refractory heaters 568-1, 568-2, 568-3. In order to operatively couple each of the refractory heaters 568-1, 568-2, 568-3 to a respective contact pad 570, a plurality of metal interconnect layers 596 are formed. In the example embodiment shown in FIG. 5, the metal interconnect layers 596 couple a contact pad to each terminal end of each of the refractory heaters 568-1, 568-2, 568-3. In order to do so, one or more vias 594 are formed through, at least, the second dielectric layer 592, the metallization layer 590, and the electrical dielectric substrate 588 so that the metal interconnect layers 596 may pass from each of the respective contact pads 570 to their respective refractory heaters 568-1, 568-2, 568-3.

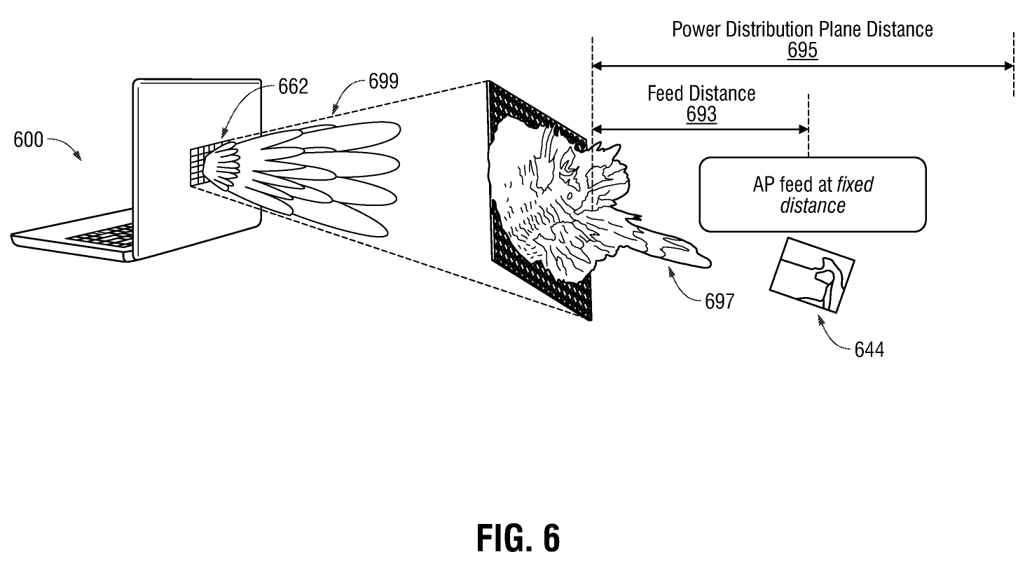

FIG. 6 graphic diagram of a reconfigurable metasurface unit cell array and its electromagnetic wave reflection properties according to an embodiment of the present disclosure. It is appreciated that this reconfigurable metasurface unit cell array 662 may be placed on any surface such as an A-cover or top cover of the laptop-type information handling system 600 described in the example embodiment herein or located on any surface within an radiofrequency environment such as an office, home, or other space. In an embodiment, the reconfigurable metasurface unit cell array 562 may be a 28 GHz mmWave reconfigurable metasurface unit cell array 562 that is used to reflect incoming EM waves off of the surface of the information handling system 600 thereby treating the information handling system 600 as a relay of EM waves within any radiofrequency environment such as an office environment.

FIG. 6 also shows that the resulting EM wave reflection pattern 699 is shown in larger detail. This EM wave reflection pattern 699 include a focused beam that has a specific directionality. As described in embodiments herein, the configuration of the metasurface reconfigurable rings via actuation of the refractory heaters causes each individual metasurface reconfigurable ring to change from an amorphous state to a crystalline state or vice versa to adjust directionality of each reconfigurable metasurface unit cell within the reconfigurable metasurface unit cell array 662. The configuration of each of these metasurface reconfigurable rings within each of the reconfigurable metasurface unit cells of the reconfigurable metasurface unit cell array 662 causes each unit cell to engage in destructive or constructive interference, between concentric rings as well as between the plurality of reconfigurable metasurface unit cells, in order to create a focused beam 697 within the EM wave reflection pattern 699. As shown in FIG. 6, this focused beam 697 is directed towards an AP 644 at a known or detected location. The feed distance 693 of this focused beam 697 may be sufficient to extend the reflected EM wave to the AP 644 so that radiofrequency signal data may be efficiently transferred from a transmitting device (not shown), reflected off of the reconfigurable metasurface unit cell array 662, and received by the AP 644 according to embodiments herein.

FIG. 6 also shows a power distribution plane distance 695. This power distribution plane distance 695 may describe the distance from the reconfigurable metasurface unit cell array 662 where the reflected EM waves reach a relatively uniform power distribution across its plane. This means that the wavefront is considered to be a far field region several wavelengths away from the reconfigurable metasurface unit cell array 662.

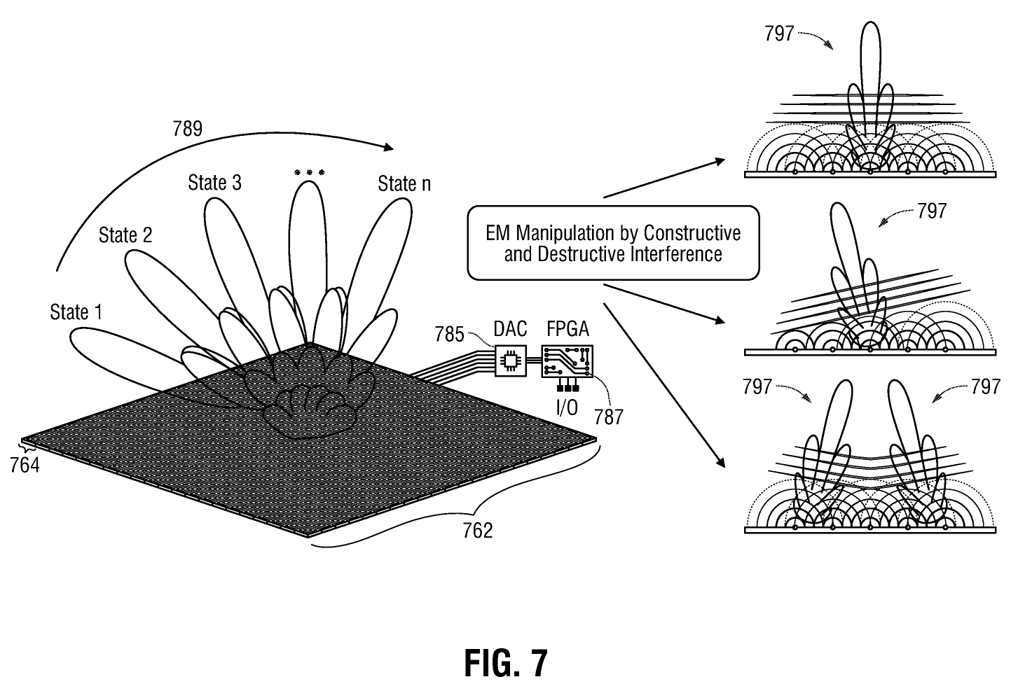

FIG. 7 is a graphic diagram of various emission states of a reconfigurable metasurface unit cell array 762 operated by a digital-to-analog converter (DAC) 793 and a field programmable gate array (FPGA) 791 operating as a metasurface controller according to an embodiment of the present disclosure. The DAC 793 and a metasurface controller such as an FPGA 791 may be formed on a printed circuit board with a power source or PMU and operatively coupled to the reconfigurable metasurface unit cell array 762. This DAC 793, metasurface controller such as an FPGA 791, and power source may be operatively coupled to contact pads of the reconfigurable metasurface unit cells of the reconfigurable metasurface unit cell array 762 in embodiments herein. FIG. 7 shows an example of the reconfigurable metasurface unit cell array 762 comprising an array of sixteen-by-sixteen reconfigurable metasurface unit cells that cooperate to direct and beamform a reflected EM wave.

As described herein, the each of the reconfigurable metasurface unit cells 764 may be controlled via use of a metasurface controller such as FPGA 787 that controls power provided from a power source, such as PMU with battery or A/C power source, to each of the refractory heaters in order to change the metasurface reconfigurable split rings from amorphous state to a crystalline state or vias versa. In the embodiment shown in FIG. 7, the metasurface PMU may provide power to the DAC 793 and an FPGA 787 that selectively applies the electrical pulses of power to each individual metasurface reconfigurable split ring of each unit cell within the reconfigurable metasurface unit cell array 762. The FPGA 787 may be any integrated circuit that contains the digital logic to actuate each refractory heater such that the state of each metasurface reconfigurable split ring can be changed between an amorphous to a crystalline state or vice versa in order to create a transmission state and direction of the reflected EM waves off of the surface of the reconfigurable metasurface unit cell array 762. In an embodiment, a look-up table may be made accessible by the FPGA 787 the describes how the FPGA 787 is to activate each of the refractory heaters in order to create destructive or constructive interference from each of the reconfigurable metasurface unit cells 764 thereby creating the directionality and feed distance necessary to reflect the EM waves towards a receiving device in focused beams 797. Again, this transmission state and direction of the reflected EM waves off of the surface of the metasurface may include the use of constructive and destructive interference to create a focused beam 797 in any of a plurality of specific directions 789. As show in FIG. 7, a direction 789 of the reflected EM waves may be controlled using phase shifting properties to change the direction 789 of the focused beam 797 or multiple focused beams 797 as shown by the individual states (e.g., “State 1,” “State 2,” “State 3,” and “State n”).

During operation, the output from the FPGA 787 or other metasurface controller may be passed through the DAC 785. The DAC 785 may convert any digital signal from the FPGA 787 into an analog signal so that the correct electrical pulse from a power source can be transmitted to a refractory heater in order to change the state of a correlated metasurface reconfigurable split ring so as to create the focused beam 797 described herein. By switching each of the metasurface reconfigurable split rings of each reconfigurable metasurface unit cell 764 of the reconfigurable metasurface unit cell array 762 between the amorphous state and the crystalline state, the reconfigurable metasurface unit cell array 762 may be configured to redirect transmitted EM waves and beam steer those EM waves in a desired direction 789. Additionally, because the heating of the phase change material of the metasurface reconfigurable split rings of the unit cells 764 can be achieved by applying thermal energy such as a pulse of heat with a certain amplitude and width (on the order of nanoseconds) through electrically insulated high-speed heaters, the constant application of power is not needed thereby reducing the need for a dedicated power source. Indeed, in some embodiments, these phase change materials of the metasurface reconfigurable split rings hold their crystalline or amorphous states as long as it is not actuated with another pulse of heat. This allows for the reconfigurable metasurface unit cell array 762 to change, within short periods of time, the directionality of the focused beam 797 or beams 797 among a plurality of directions 789 such that data may be transmitted from a variety of locations, relay by and reflected off of the surface of the reconfigurable metasurface unit cell array 762, and towards a variety of locations. This allows for data from these locationally distinct transmitting devices to be transmitted to locationally distinct receiving devices using the reconfigurable metasurface unit cell array 762 as an EM wave reflective surface.

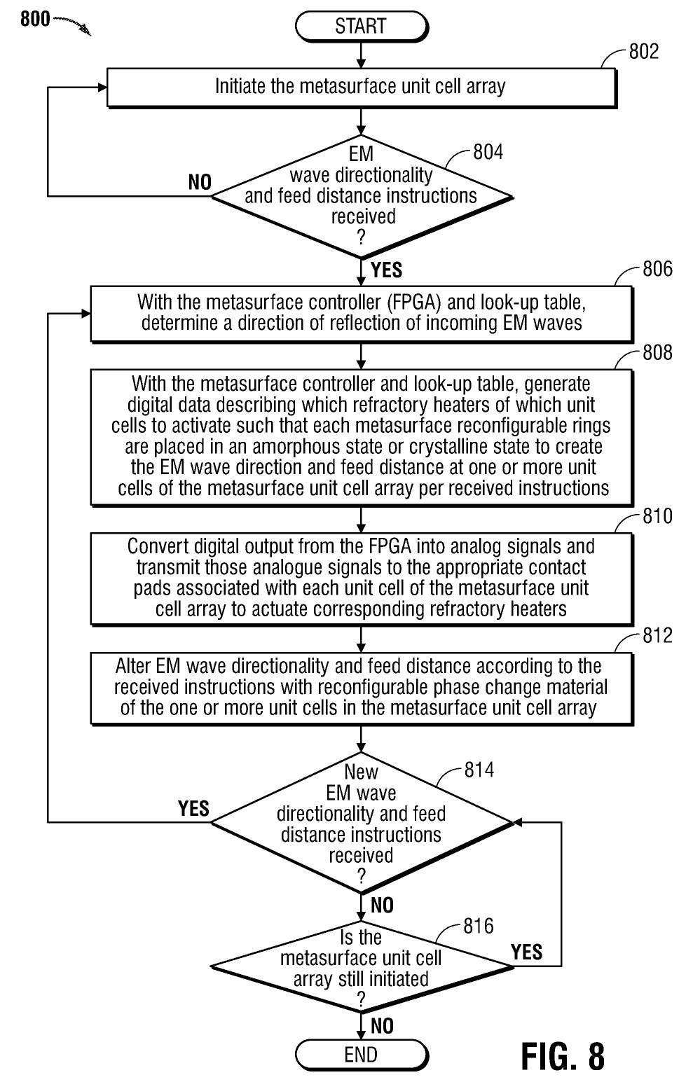

FIG. 8 is a block diagram of a method 800 of controlling a reconfigurable metasurface unit cell array to dynamically change the directionality and feed distance of reflected EM wave beams according to an embodiment of the present disclosure. The reconfigurable metasurface unit cell array used in this method may be similar to those reconfigurable metasurface unit cell arrays described in connection with, for example, FIGS. 1,4,5, and 7. The reconfigurable metasurface unit cell array may include a plurality of reconfigurable metasurface unit cells that are individually controlled using a metasurface PMU or power source, a metasurface controller such as an FPGA, and DAC or other components as described herein.

At block 802, the method 800 may include initiating the reconfigurable metasurface unit cell array. In an embodiment, the reconfigurable metasurface unit cell array may be initiated by a user actuating a power button on the reconfigurable metasurface unit cell array. The metasurface PMU may then proceed to power a metasurface controller such as an FPGA and DAC in order to receive EM wave directionality and feed distance instructions or to detect from the reconfigurable metasurface unit cell array directionality and feed distance of a source wireless device and of a target receiving wireless device. In an embodiment, the reconfigurable metasurface unit cell array may be placed on a surface where EM waves may be reflected off from a source wireless device in order to reach a receiving device. These surfaces may include an A-cover of an information handling system such as that shown in FIG. 6, a wall, and the side of a building, among other surfaces in a radiofrequency environment where millimeter EM waves may be relayed around objects that would otherwise prevent penetration.

At block 804, the method 800 may include determining whether an EM wave directionality and feed distance instructions have been received or detected between the source wireless device and the target receiving wireless device. In an embodiment, these EM wave directionality and feed distance instructions may be provided via a wireless connection from, for example, a transmitting wireless information handling system or other source wireless computing device that is provided data descriptive of the radiofrequency environment in which the transmitting source wireless computing device and receiving wireless device are located. For example, the radiofrequency environment may include an office building setting where the walls of the individual rooms and offices prevent such short wavelengths from passing through to other wireless devices. In other embodiments, the reconfigurable metasurface unit cells may operate as an array antenna to detect wireless signal directionality from the source wireless computing device and to the target receiving wireless device and provide this to the metasurface controller or other hardware controller to determine wave directionality and feed distance instructions for adjustment. The EM wave directionality and feed distance instructions, in an embodiment, may include location data or direction detected of a receiving wireless device such as a receiving wireless information handling system, an access point, a base station, and the like. Where no EM wave directionality and feed distance instructions have been received, the wireless controller FPGA and DCA do not change any directionality and feed distance characteristics of the reconfigurable metasurface unit cell array and the reconfigurable metasurface unit cell array continues in its current state with the metasurface reconfigurable rings in their current amorphous state or crystalline state.

However, where the EM wave directionality and feed distance instructions have been received, the method 800 continues to block 806. At block 806, the method 800 further includes determining a direction of reflection of incoming EM waves with the metasurface controller FPGA and a look-up table accessible to the metasurface FPGA. This look-up table may be maintained on a non-volatile memory device associated with and accessible to the metasurface controller FPGA so that the FPGA may generate appropriate digital signals such that the directionality and feed distance may be replicated at the reconfigurable metasurface unit cell array according to the received EM wave directionality and feed distance instructions.

Thus, at block 808, the method 800 also includes generating digital data, as output from the metasurface controller FPGA, describing which contact pads of the refractory heaters of which reconfigurable metasurface unit cells to activate such that each of the metasurface reconfigurable rings are placed in an amorphous state or crystalline state to create the EM wave direction and feed distance beam directionality per the received EM wave directionality and feed distance instructions. As shown in FIGS. 2A and 2B and described herein, each reconfigurable metasurface unit cell of the reconfigurable metasurface unit cell array includes concentrically formed first metasurface reconfigurable split ring, second metasurface reconfigurable split ring, and third metasurface reconfigurable split ring made of any type of phase change materials such as GeTe, SbTe, or GeSbTe among other similar non-volatile phase change materials. In an embodiment, a non-reconfigurable metal fixed ring and non-reconfigurable metal fixed center node made of a metal such as Au, Cu, Al, and Ni among other types of conductive metals may also be placed on the layer formed by the metasurface reconfigurable rings.

In order to maintain the active beam steering capabilities of each of the metasurface reconfigurable split rings a gap in each metasurface reconfigurable split ring may be bridged using a conductive bridge. The conductive bridge allows for induced currents in each of the metasurface reconfigurable split rings when in a conductive crystalline state to create radiated fields that form the reflected wave patterns described herein.

As described herein, the first refractory heater, the second refractory heater, and the third refractory heater are formed under the metasurface reconfigurable rings. The refractory heaters may each, individually and selectively, heat their respective metasurface reconfigurable split ring such that, when a power source is applied to the first refractory heater, the first refractory heater pulse heats the first metasurface reconfigurable split ring, the second refractory heater pulse heats the second metasurface reconfigurable split ring, and third refractory heater 268-3, the third refractory heater pulse heats the third metasurface reconfigurable split ring. Thus, the states of each of the metasurface reconfigurable split rings may be individual controlled via pulse heating of the individual refractory heaters such that the states of the metasurface reconfigurable split rings may be switched from their amorphous states to their crystalline states or vice versa based on the EM wave directionality and feed distance instructions.

At block 810, the method 800, therefore, includes converting digital output from the metasurface controller FPGA into analog signal and power via the DAC and a power source and transmitting those analogue signals and power to the appropriate contact pads associated with each reconfigurable metasurface unit cell of the reconfigurable metasurface unit cell array. Again, the applied voltage and current to each of the refractory heaters generates a heat pulse to change the state of the non-volatile phase change material of each metasurface reconfigurable split ring. The amplitude and duration of an applied heat pulse to switch states may depend on the type of non-volatile phase change material used and the present specification contemplates that a plurality of non-volatile phase change materials may be used necessitating changes in these applied voltages and currents depending on the phase change material used.

At block 812, as a result of the electrical signals and power to the contact pads from the DAC, the EM wave directionality and feed distance are altered accordingly to the originally received EM wave directionality and feed distance instructions. Again, the metasurface reconfigurable rings may be used to invoke constructive and/or destructive interference in the reconfigurable metasurface unit cells in directions such that a beam lobe is created that is directed towards or focused towards a receiving wireless device.

At block 814, the method 800 continues by detecting whether a new set of EM wave directionality and feed distance instructions have been received or detected at the metasurface controller FPGA. Where a new set of EM wave directionality and feed distance instructions have been received or detected from a source wireless device, the method 800 continues to block 806 with the metasurface controller FPGA executing those processes described herein. Where no new EM wave directionality and feed distance instructions have been received, the method 800 continues to block 816.

At block 816, the method 800 includes determining if the reconfigurable metasurface unit cell array is still initiated. Where the reconfigurable metasurface unit cell array is still initiated, the method 800 proceeds to block 814 with the FPGA monitoring to determine if new EM wave directionality and feed distance instructions have been received as described herein. Where the reconfigurable metasurface unit cell array is no longer initiated, the method 800 may end here.

The processes or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A reconfigurable metasurface unit cell array to manipulate reflection of an electromagnetic wave, comprising:
a plurality of reconfigurable metasurface unit cells, each of the plurality of reconfigurable metasurface unit cells including a plurality of concentric metasurface reconfigurable split rings each formed of a non-volatile phase change material in a first substrate and having a conductive bridge in the first substrate to complete a ring structure of each concentric metasurface reconfigurable split ring;
a plurality of refractory heaters formed in an electrically isolated second substrate corresponding to each of the plurality of concentric metasurface reconfigurable split rings to selectably heat each of the plurality of concentric metasurface reconfigurable split rings to switch between a crystalline conductive state and an amorphous dielectric state; and
a plurality of contact pads to operatively couple each of the plurality of refractory heaters in the second substrate to a power source and a metasurface controller to control power pulses to each of the plurality of refractory heaters to change the electromagnetic reflective properties of plurality of concentric metasurface reconfigurable split rings in the reconfigurable metasurface unit cell array.

2. The reconfigurable metasurface unit cell array of claim 1 further comprising:
a plurality of non-reconfigurable metal fixed outer rings, each of the plurality of non-reconfigurable metal fixed outer rings formed around each of the plurality of the concentric metasurface reconfigurable split rings in the first substrate in each of the plurality of reconfigurable metasurface unit cell, where the plurality of non-reconfigurable metal fixed outer rings forms a passive state conductive ring within each of the plurality of reconfigurable metasurface unit cells.

3. The reconfigurable metasurface unit cell array of claim 1 further comprising:
a plurality of non-reconfigurable metal fixed center nodes, each of the plurality of non-reconfigurable metal fixed center nodes formed within a center concentric metasurface reconfigurable split ring in the first substrate, the plurality of non-reconfigurable metal fixed center nodes forming a passive state conducive pad within each of the plurality of reconfigurable metasurface unit cells.

4. The reconfigurable metasurface unit cell array of claim 1, wherein the non-volatile phase change material of each of the plurality of concentric metasurface reconfigurable split rings is made of germanium telluride (GeTe) that selectively switches between the crystalline conductive state and the amorphous dielectric state when a heat pulse is applied.

5. The reconfigurable metasurface unit cell array of claim 1, wherein the non-volatile phase change material of each of the plurality of concentric metasurface reconfigurable split rings is made of antimony telluride (SbTe) that selectively switches between the crystalline conductive state and the amorphous dielectric state when a heat pulse is applied.

6. The reconfigurable metasurface unit cell array of claim 1 further comprising:
a dielectric layer formed between the first substrate comprising the plurality of concentric metasurface reconfigurable split rings and the second substrate comprising the plurality of refractory heaters to electrically isolate the plurality of concentric metasurface reconfigurable split rings and the plurality of refractory heaters.

7. The reconfigurable metasurface unit cell array of claim 1 further comprising:
a dielectric layer formed below the second substrate;
a groundling layer formed below the dielectric layer; and
a second dielectric layer formed below the grounding layer and above the plurality of contact pads.

8. The reconfigurable metasurface unit cell array of claim 1 further comprising:
a plurality of metal interconnect lines operatively coupling each of the contact pads to respective terminal ends of the plurality of refractory heaters.

9. A reconfigurable metasurface unit cell within a reconfigurable metasurface unit cell array used to manipulate reflection of an electromagnetic wave, comprising:
a first metasurface reconfigurable split ring formed of a non-volatile phase change material in a first substrate;
a second metasurface reconfigurable split ring formed of the non-volatile phase change material concentrically spaced around the first metasurface reconfigurable split ring in the first substrate;
a third metasurface reconfigurable split ring formed of the non-volatile phase change material concentrically spaced around the second metasurface reconfigurable split ring in the first substrate;
a first refractory heater formed in a second substrate to selectably heat the first metasurface reconfigurable split ring to switch the first metasurface reconfigurable split ring between a crystalline conductive state and an amorphous dielectric state;
a second refractory heater to selectably heat the second metasurface reconfigurable split ring to switch the second metasurface reconfigurable split ring between the crystalline conductive state and the amorphous dielectric state;
a third refractory heater to selectably heat the third metasurface reconfigurable split ring to switch the third metasurface reconfigurable split ring between the crystalline conductive state and the amorphous dielectric state; and
a plurality of contact pads to operatively couple the first refractory heater, the second refractory heater, the third refractory heater to a metasurface controller to pulse power from a power source to the first refractory heater, the second refractory heater, and the third refractory heater to change the electromagnetic reflective properties of the reconfigurable metasurface unit cell within the reconfigurable metasurface unit cell array.

10. The reconfigurable metasurface unit cell of claim 9 further comprising:
a conductive bridge formed in the first substrate for each of the first metasurface reconfigurable split ring, the second metasurface reconfigurable split ring, and the third metasurface reconfigurable split ring to complete a ring structure of each metasurface reconfigurable split ring when in a crystalline conductive state.

11. The reconfigurable metasurface unit cell of claim 9 further comprising:
a non-reconfigurable metal fixed outer ring formed around the third metasurface reconfigurable metal fixed split ring in the first substrate, the non-reconfigurable metal fixed outer ring forming a base reflective split ring within each of the plurality of unit cells.

12. The reconfigurable metasurface unit cell of claim 9 further comprising:
a non-reconfigurable metal fixed center node formed within the first metasurface reconfigurable split ring in the first substrate, the non-reconfigurable metal fixed center node forming a passive state conductive pad within the unit cell.

13. The reconfigurable metasurface unit cell of claim 9 further comprising:
each of the first metasurface reconfigurable split ring, the second metasurface reconfigurable split ring, and the third metasurface reconfigurable split ring made with germanium telluride (GeTe) as the non-volatile phase change material that selectively switches between the crystalline conductive state and the amorphous dielectric state when a heat pulse is applied.

14. The reconfigurable metasurface unit cell of claim 9 further comprising:
a dielectric layer formed between a first substrate comprising the first metasurface reconfigurable split ring, the second metasurface reconfigurable split ring, and the third metasurface reconfigurable split ring and the second substrate comprising the first refractory heater, the second refractory heater, and the third refractory heater for electrical insulation that is heat conductive.

15. The reconfigurable metasurface unit cell of claim 9 further comprising:
a dielectric layer formed below the second substrate;
a groundling layer formed below the dielectric layer; and
a second dielectric layer formed below the grounding layer and above the plurality of contact pads operably coupling the plurality of refractory heaters to the metasurface power source.

16. A reconfigurable metasurface to manipulate reflection of an electromagnetic wave, comprising:
a plurality of reconfigurable metasurface unit cells, each of the plurality of reconfigurable metasurface unit cells including:
a plurality of concentric metasurface reconfigurable split rings formed of a non-volatile phase change material in a first substrate;
a plurality of concentric refractory heaters in a second substrate to selectably heat each of the plurality of metasurface reconfigurable split rings to switch, individually, the non-volatile phase change material each of the plurality of concentric metasurface reconfigurable split rings between a crystalline conductive state and an amorphous dielectric state; and
a metasurface power source to provide controller power pulses to each of the plurality of concentric refractory heaters via a plurality of contact pads operatively coupled to the plurality of concentric refractory heaters in the second substrate.

17. The reconfigurable metasurface of claim 16 further comprising:
each reconfigurable metasurface unit cell including a non-reconfigurable metal fixed outer ring formed around each of the plurality of concentric metasurface reconfigurable split rings, where the non-reconfigurable metal fixed outer ring forms a passive state conductive ring within each of the plurality of reconfigurable metasurface unit cells.

18. The reconfigurable metasurface of claim 16 further comprising:
each reconfigurable metasurface unit cell including a non-reconfigurable metal fixed center node formed within an inner concentric metasurface reconfigurable split ring in an arrangement the plurality of the concentric metasurface reconfigurable split rings, the non-reconfigurable metal fixed center node forming a passive state conductive pad within each of the plurality of reconfigurable metasurface unit cells.

19. The reconfigurable metasurface of claim 16 further comprising:
a dielectric layer formed between the first substrate comprising the metasurface reconfigurable split rings and the second substrate comprising the refractory heaters for electrical insulation and that is heat conductive.

20. The reconfigurable metasurface of claim 16 further comprising
an dielectric layer formed below the second substrate;
a groundling layer formed below the dielectric layer; and
a second dielectric layer formed below the grounding layer and above the plurality of contact pads operably coupling the plurality of refractory heaters to the metasurface power source.
